(19) United States
(12) Patent Application Publication
(10) Pub. No.: US 2024/0305577 A1
(43) Pub. Date: Sep. 12, 2024

(54) TECHNIQUES FOR REDUCING NETWORK CONGESTION DUE TO MULTICAST COMMUNICATIONS

(71) Applicant: NVIDIA CORPORATION, Santa Clara, CA (US)

(72) Inventors: John Martin SNYDER, San Francisco, CA (US); Nan JIANG, Sudbury, MA (US); Alan Lynn DAVIS, Coalville, UT (US); Larry Robert DENNISON, Mendon, MA (US)

(21) Appl. No.: 18/493,713

(22) Filed: Oct. 24, 2023

Related U.S. Application Data
(60) Provisional application No. 63/487,198, filed on Feb. 27, 2023.

(51) Int. Cl. H04L 47/35; H04L 47/12; H04L 47/28

(52) U.S. Cl. CPC H04L 47/35; H04L 47/12; H04L 47/28

(57) ABSTRACT

One embodiment of a method for reducing network congestion cause by multicast communications includes receiving, via a network, first data associated with one or more multicast operations, determining a congestion state of the network based on the first data, and performing one or more operations to reduce an amount of second data that is transmitted via the network based on the congestion state of the network.

### CROSS-REFERENCE TO RELATED APPLICATIONS

This application claims priority benefit of the United States Provisional patent application titled, “TECHNIQUES FOR MANAGING NETWORK MULTICAST CONGESTION,” filed on Feb. 27, 2023 and having Ser. No. 63/487,198. The subject matter of this related application is hereby incorporated herein by reference.

### BACKGROUND

### Technical Field

Embodiments of the present disclosure relate generally to computer science and computer networking and, more specifically, to techniques for reducing network congestion due to multicast communications.

### Description of the Related Art

A multicast communication is a group communication transmitted from one or more source endpoints in a computer network to multiple destination endpoints in the computer network. Among other things, multicast communications can be used to implement collective operations that are performed by multiple processing units in parallel. For example, all-reduce operations comprise one type of collective operation that includes a gather step in which data is collected from multiple processing units and a scatter step in which the gathered data is distributed to each of the multiple parallel processing units. All-reduce operations are oftentimes used by machine learning and high-performance computing (HPC) workloads that are spread across multiple processing units running different portions of those workloads in parallel. Both the gather and scatter steps in an all-reduce operation can be implemented using multicast communications that are broadcast to the multiple processing units.

One drawback of multicast communications is that these types of communications can cause significant congestion in a computer network when the network packets associated with the multicast communications are transmitted to multiple destination endpoints and replicated by switches within the network during that transmission process. The network congestion caused by multicast communications can cause packet transmission delays within the network and can even result in packets failing to reach the desired destination endpoints.

Conventional network congestion control techniques are designed to mitigate network congestion caused by unicast communications in which a source endpoint communicates with a single destination endpoint. Accordingly, conventional network congestion control techniques do not usually account for the additional network traffic caused by multicast communications, in which one or more source endpoints communicate with multiple destination endpoints. As a result, conventional network congestion control techniques are, as a general matter, very slow to reduce the network congestion caused by multicast communications.

As the foregoing illustrates, what is needed in the art are more effective techniques for reducing network congestion due to multicast communications.

### SUMMARY

One embodiment of the present disclosure sets forth a computer-implemented method for reducing network congestion caused by multicast communications. The method includes receiving, via a network, first data associated with one or more multicast operations. The method further includes determining a congestion state of the network based on the first data. In addition, the method includes performing one or more operations to reduce an amount of second data that is transmitted via the network based on the congestion state of the network.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is that the disclosed techniques can more effectively reduce network congestion caused by multicast communications. In this regard, the disclosed techniques can more quickly reduce the packet transmission delays and packet losses oftentimes experienced when multicast communications cause network congestion. In addition, the disclosed techniques do not cause much, if any, loss of network throughput when implemented to reduce the network congestion caused by multicast communications. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram illustrating an interconnect fabric implemented according to one or more aspects of the various embodiments;

FIG. 2 illustrates a computer system that includes a layer 1 (L1) switch of FIG. 1, according to various embodiments;

FIG. 3 is a more detailed illustration of the L1 switch of FIG. 2, according to various embodiments;

FIG. 4 illustrates how the unmatched array and the injection rate limiting (IRL) tokens of FIG. 3 are reduced, according to various embodiments;

FIG. 5 illustrates how the unmatched array, the IRL tokens, and the local operations counter of FIG. 3 are reduced, according to various embodiments;

FIG. 6 illustrates how the unmatched array, the IRL tokens, the local operations counter, the outstanding array, and the remote operations queue of FIG. 3 are reduced, according to various embodiments;

FIG. 7A illustrates how network congestion is managed using multicast congestion control, according to various embodiments;

FIG. 7B illustrates how network congestion is managed using multicast congestion control and unicast congestion control, according to various embodiments;

FIG. 8 is a flow diagram of method steps for updating switch data structures in response to receiving a multicast request, according to various embodiments;

FIG. 9 is a flow diagram of method steps for updating switch data structures when transmitting a multicast request, according to various embodiments;

FIG. 10 is a flow diagram of method steps for updating switch data structures in response to receiving a multicast response, according to various embodiments;

FIG. 11 is a flow diagram of method steps for ensuring that entries in an unmatched array are greater than or equal to corresponding entries in an outstanding array, according to various embodiments; and

FIG. 12 is a flow diagram of method steps for performing unicast congestion control along with multicast congestion control, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### GENERAL OVERVIEW

Embodiments of the present disclosure provide techniques for reducing network congestion due to multicast communications. In some embodiments, a layer 1 (L1) switch determines the congestion state of a network based on received data associated with multicast operations, and the L1 switch reduces an amount of data that is transmitted based on the congestion state of the network. In particular, in some embodiments, when the L1 switch receives multicast requests from remote endpoints, the L1 switch decrements entries in an unmatched array that are associated with the remote endpoints. Then, when a local endpoint transmits a multicast request, the L1 switch (1) increments the entries in the unmatched array, and (2) decreases the number of injection rate limiting (IRL) tokens available for the local endpoint to transmit requests based on the transmission of the multicast request and the entries in the unmatched array. In some embodiments, the L1 switch also (1) decrements entries in an outstanding operations array that are associated with remote endpoints when multicast requests are received from the remote endpoints, and (2) adds an entry to a remote operations queue that indicates expiration times of the received multicast requests. When the expiration times elapse, the entries in the outstanding operations array that are associated with the remote endpoints are incremented, and corresponding entries in the unmatched array are set equal to the entries in the outstanding operations array if the corresponding entries are smaller than the entries in the outstanding operations array. In addition, in some embodiments, the L1 switch computes a reduction to a watermark that is equivalent to a number of tokens consumed over a period of time due to the multicast network congestion management, and, if the reduction to the watermark is less than a baseline constant reduction referred to herein as the multiplicative decrease (MD), then the L1 switch performs unicast congestion control by reducing the watermark by the MD.

The techniques disclosed herein for reducing network congestion to due multicast communications have many real-world applications. For example, those techniques could be used to throttle multicast request traffic during collective operations, such as the all-reduce operations that are sometimes used by machine learning and high-performance computing (HPC) workloads, or in any other suitable application.

The above examples are not in any way intended to be limiting. As persons skilled in the art will appreciate, as a general matter, the techniques for training a machine learning model using heterogeneous continual learning can be implemented in any suitable application.

### System Overview

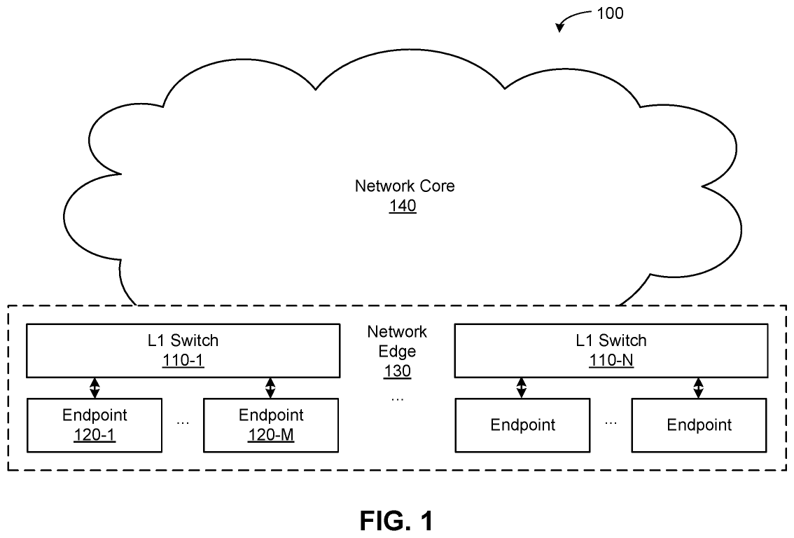

FIG. 1 is a block diagram illustrating an interconnect fabric 100 implemented according to one or more aspects of the various embodiments. As used herein, the term “interconnect fabric” refers to a network of devices, such as layer 1 (L1) switches, that connect multiple endpoints that communicate with one another using a same communication protocol or link. For example, the communication protocol could be NVLink™, and the L1 switches could be NVSwitches that are commercially available from NVIDIA® Corporation of Santa Clara, California.

As shown, the interconnect fabric 100 includes a network of L1 switches, shown as L1 switches 110-1 to 110-N(referred to herein collectively as L1 switches and individually as an L1 switch) that connect multiple endpoints over a communication protocol. Illustratively, endpoints 120-1 to 120-M (referred to herein collectively as endpoints 120 and individually as an endpoint 120) are local to the L1 switch 110-1. Although shown as being distinct from the L1 switch 110-1, in some embodiments, the endpoints 120 can be ports of the L1 switch 110-1 via which processing units (e.g., graphics processing units (GPUs) and/or central processing units (CPUs)), storage units (e.g., memories), and/or networking units (e.g., network interface cards) communicate. In some embodiments, the switches 110 and endpoints can be within a single server, within multiple servers within a single rack, or distributed across multiple server racks.

An area 130 representing connections between each endpoint 120 and the respective network of switches 110 is referred to herein as an “edge” of the interconnect fabric 100. An area 140 representing connections between the L1 switches 110 and other switches (not shown), such as layer 2 (L2) switches, is referred to herein as a “core” of the interconnect fabric 100. The network congestion reduction techniques disclosed herein take place in the edge of the interconnect fabric 100. The interconnect fabric 100 and the endpoints (e.g., endpoints 120) can be part of a server or servers, such as servers in a data center.

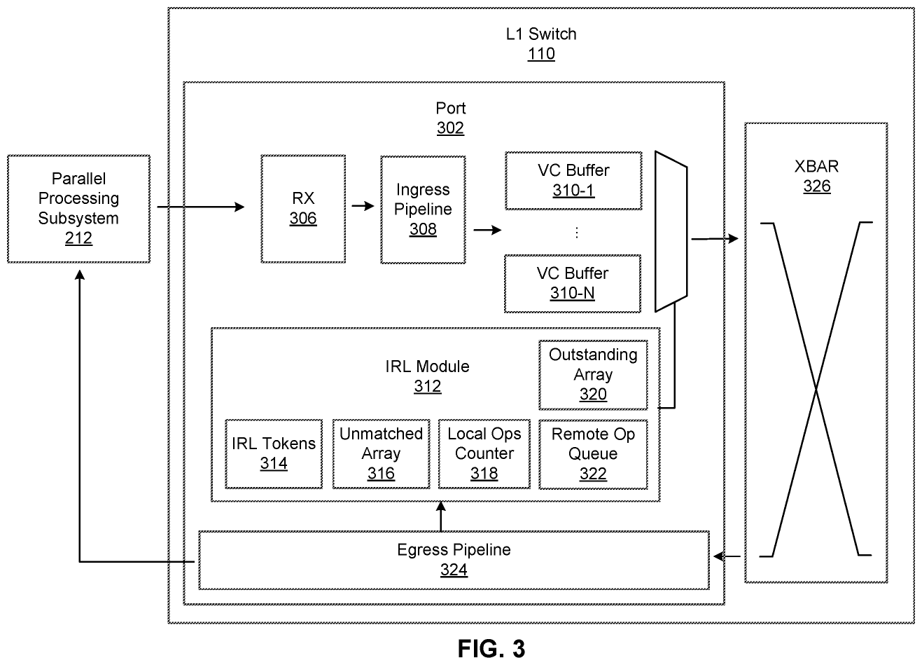

Each endpoint (e.g., each of endpoints 120) can transmit requests to any other endpoint(s) connected to the interconnect fabric 100 and can also respond to any other endpoint(s) connected to the interconnect fabric. In some embodiments, an endpoint can transmit a request when sufficient injection rate limiting (IRL) tokens are available. In some embodiments, an endpoint can, among other things, receive multicast requests from remote endpoints and transmit multicast requests to the remote endpoints. For example, the multicast requests can be transmitted during a collective operation, such as an all-reduce operation by a machine learning or high-performance computing (HPC) workload, or at any other suitable time. In such cases, the L1 switches 110 can reduce network congestion due to multicast communications according to techniques described herein in conjunction with FIGS. 3-12.

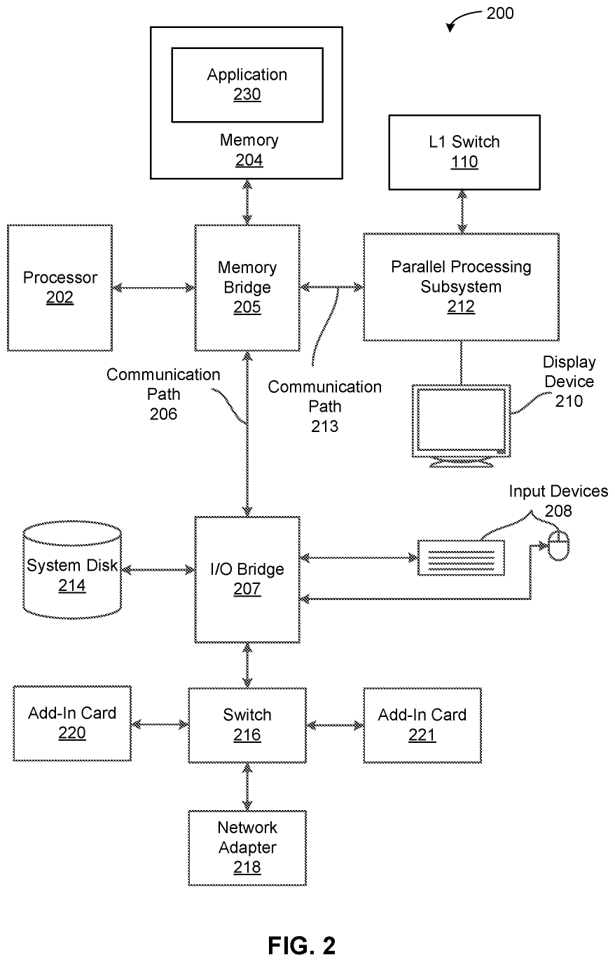

FIG. 2 illustrates a computer system 200 that includes an L1 switch of FIG. 1, according to various embodiments. In some embodiments, the computer system 200 is a server machine operating in a data center or a cloud computing environment that provides scalable computing resources as a service over a network.

In various embodiments, the computer system 200 includes, without limitation, a processor 202 and a memory 204 coupled to a parallel processing subsystem 212 via a memory bridge 205 and a communication path 213. The memory bridge 205 is further coupled to an I/O (input/output) bridge 207 via a communication path 206, and the I/O bridge 207 is, in turn, coupled to a switch 216.

In some embodiments, the I/O bridge 207 is configured to receive user input information from optional input devices 208, such as a keyboard or a mouse, and forward the input information to the processor 202 for processing via the communication path 206 and the memory bridge 205. In some embodiments, the computer system 200 may be a server machine in a cloud computing environment. In such embodiments, the computer system 200 may not have input devices 208. Instead, the computer system 200 may receive equivalent input information by receiving commands in the form of messages transmitted over a network and received via the network adapter 218. In some embodiments, the switch 216 is configured to provide connections between the I/O bridge 207 and other components of the computer system 200, such as a network adapter 218 and various add-in cards 220 and 221.

In some embodiments, the I/O bridge 207 is coupled to a system disk 214 that may be configured to store content and applications and data for use by the processor 202 and the parallel processing subsystem 212. In some embodiments, the system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In various embodiments, other components, such as universal serial bus or other port connections, compact disc drives, digital versatile disc drives, film recording devices, and the like, may be connected to the I/O bridge 207 as well.

In various embodiments, the memory bridge 205 may be a Northbridge chip, and the I/O bridge 207 may be a Southbridge chip. In addition, communication paths 206 and 213, as well as other communication paths within the computer system 200, may be implemented using any technically suitable protocols, including, without limitation, AGP (Accelerated Graphics Port), HyperTransport, or any other bus or point-to-point communication protocol known in the art.

In some embodiments, the parallel processing subsystem 212 comprises a graphics subsystem that delivers pixels to an optional display device 210 that may be any conventional cathode ray tube, liquid crystal display, light-emitting diode display, or the like. In such embodiments, the parallel processing subsystem 212 incorporates circuitry optimized for graphics and video processing, including, for example, video output circuitry. Such circuitry may be incorporated across one or more parallel processing units (PPUs), also referred to herein as parallel processors, included within the parallel processing subsystem 212. In other embodiments, the parallel processing subsystem 212 incorporates circuitry optimized for general purpose and/or compute processing. Again, such circuitry may be incorporated across one or more PPUs included within the parallel processing subsystem 212 that are configured to perform such general purpose and/or compute operations. In yet other embodiments, the one or more PPUs included within the parallel processing subsystem 212 may be configured to perform graphics processing, general purpose processing, and compute processing operations. The system memory 204 includes at least one device driver configured to manage the processing operations of the one or more PPUs within the parallel processing subsystem 212. In addition, the system memory 204 includes an application 230. The application 230 can be any suitable type of application that transmits and receives multicast requests. For example, in some embodiments, the application 230 can be a machine learning or HPC application that transmits and receives multicast requests during collective operations, such as all-reduce operations, or at any other suitable time.

In various embodiments, the parallel processing subsystem 212 may be integrated with one or more of the other elements of FIG. 2 to form a single system. For example, the parallel processing subsystem 212 may be integrated with the processor 202 and other connection circuitry on a single chip to form a system on chip (SoC).

In some embodiments, the processor 202 is the master processor of the computer system 200, controlling and coordinating operations of other system components. In some embodiments, the processor 202 issues commands that control the operation of PPUs. In some embodiments, the communication path 213 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. The connection topology, including the number and arrangement of bridges, the number of CPUs 202, and the number of parallel processing subsystems 212, may be modified as desired. For example, in some embodiments, the system memory 204 could be connected to processor 202 directly rather than through the memory bridge 205, and other devices would communicate with system memory 204 via the memory bridge 205 and the processor 202. In other embodiments, the parallel processing subsystem 212 may be connected to the I/O bridge 207 or directly to the processor 202, rather than to the memory bridge 205. In still other embodiments, the I/O bridge 207 and the memory bridge 205 may be integrated into a single chip instead of existing as one or more discrete devices. In certain embodiments, one or more components shown in FIG. 2 may not be present. For example, the switch 216 could be eliminated, and the network adapter 218 and the add-in cards 220, 221 would connect directly to the I/O bridge 207. Lastly, in certain embodiments, one or more components shown in FIG. 2 may be implemented as virtualized resources in a virtual computing environment, such as a cloud computing environment. In particular, the parallel processing subsystem 212 may be implemented as a virtualized parallel processing subsystem in some embodiments. For example, the parallel processing subsystem 212 could be implemented as a virtual graphics processing unit (GPU) that renders graphics on a virtual machine (VM) executing on a server machine whose GPU and other physical resources are shared across multiple VMs.

As shown, the parallel processing subsystem 212 is in communication with a L1 switch 110, which can correspond to one of the L1 switches 110 described above in conjunction with FIG. 1. In some embodiments, the parallel processing subsystem 212 can, among other things, receive multicast requests and transmit multicast requests via an L1 switch, such as L1 switch 110. As described, the multicast requests can be transmitted during, for example, the collective operations when the application 230 is a machine learning or HPC application. In such cases, the L1 switch can reduce network congestion due to the multicast communications according to techniques described herein in conjunction with FIGS. 3-12.

### Multicast Congestion Control

FIG. 3 is a more detailed illustration of the L1 switch 110 of FIG. 2, according to various embodiments. As shown, the L1 switch 110 (also referred to herein as “switch 110”) includes a port 302 and a crossbar (XBAR) 326. Although one port 302 of the L1 switch 110 is shown for illustrative purposes, a switch can include any number of ports in some embodiments.

As shown, the port 302 includes a receiver (RX) 306, an ingress pipeline 308, an egress pipeline 324, virtual channel (VC) buffers 310-1 to 310-N(referred to herein collectively as VC buffers 310 and individually as a VC buffer 310). The receiver 306 is configured to receive packets, e.g., response and request packets, from an endpoint, shown as the parallel processing subsystem 212, and pass the packets on to the ingress pipeline 308. Although described herein primarily with respect to packets for simplicity, in some embodiments data associated with multicast communications, such as multicast requests and responses, can be transmitted at any suitable level of granularity, such as flits or bytes, and techniques disclosed herein for multicast congestion control can be modified to be based on the transmission and reception of such data rather than packets. Illustratively, the ingress pipeline 308 is configured to receive request packets from the receiver 306 and move the packets to the VC buffers 310. The VC buffers 310 are connected to the crossbar 326, which transmits request packets from the parallel processing subsystem 212 to other endpoints 120 in the interconnect fabric 100 and receives response packets therefrom. Before a VC buffer 310 injects a packet for transmission, the VC buffer 310 checks if there are available IRL tokens 314 for the transmission, as discussed in greater detail below.

In some embodiments, the switch 110 can be implemented as a hardware processor. In such cases, the receiver 306, the ingress pipeline 308, the egress pipeline 324, and the IRL module 312 can be implemented as circuitry elements in the processor. In some other embodiments, the receiver 306, the ingress pipeline 308, the egress pipeline 324, and the IRL module 312 can be implemented as software that executes on a processor of a switch, or as any technically feasible combination of hardware and software.

As shown, the IRL module 312 maintains IRL tokens 314, an unmatched array 316, a local operations counter 318, an outstanding array 320, and a remote operations queue 322. Although described herein primarily with respect to the IRL tokens 314, the unmatched array 316, the local operations counter 318, the outstanding array 320, and the remote operations queue 322 as reference examples of data structures that can be used to determine the congestion state of a network, in some embodiments, any technically feasible data structures can be used to determine the congestion state of a network based on received data associated with multicast operations, and an amount of data that is transmitted by the switch 110 can then be reduced based on the congestion state of the network.

The IRL tokens 314 is an integer value that indicates a number of available IRL tokens. The IRL tokens 314 enable an endpoint to transmit packets if the endpoint has sufficient IRL tokens. If the endpoint does not have sufficient tokens, then the endpoint must wait until tokens become available for the endpoint to transmit packets. The IRL module 312 generates tokens over time and consumes tokens (1) when transmitting packets from an endpoint, and (2) to account for other multicast traffic in the network, as discussed in greater detail below.

The unmatched array 316 is used to track whether multicast requests that the switch 110 receives have yet to match with corresponding local requests. In some embodiments, the unmatched array 316 can be implemented as an array of size N−1, where N is the number of endpoints in the system. Each entry in the unmatched array 316 is associated with a respective remote endpoint. A positive entry value indicates that a local multicast request was transmitted to other endpoints and was not matched with a corresponding request from the remote endpoint associated with the entry. A negative entry value indicates that the local endpoint received a remote multicast request that was not matched with a local multicast request.

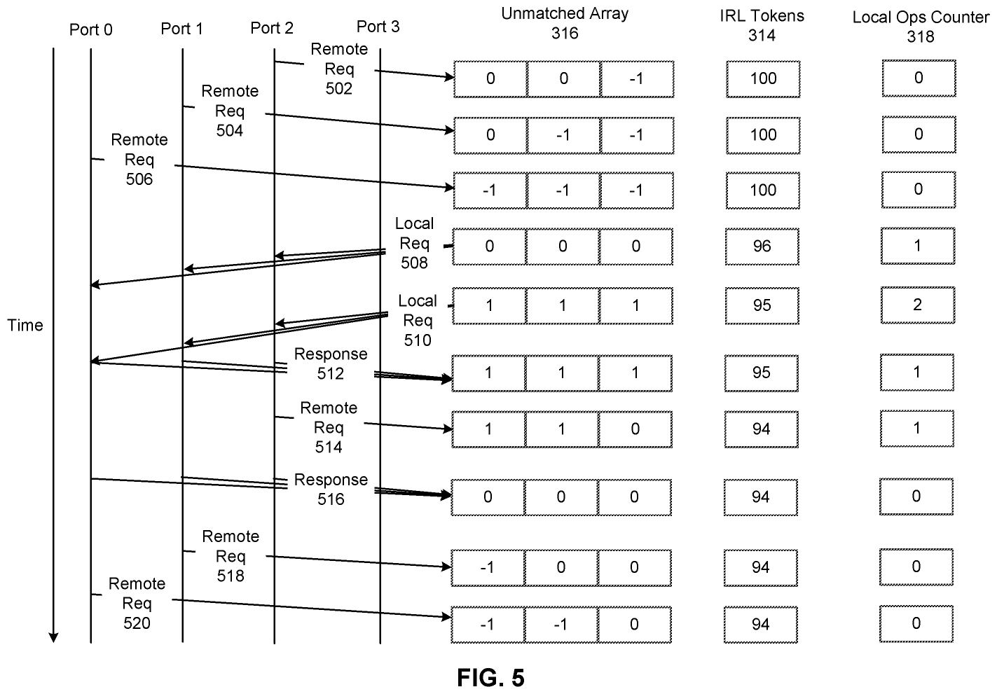

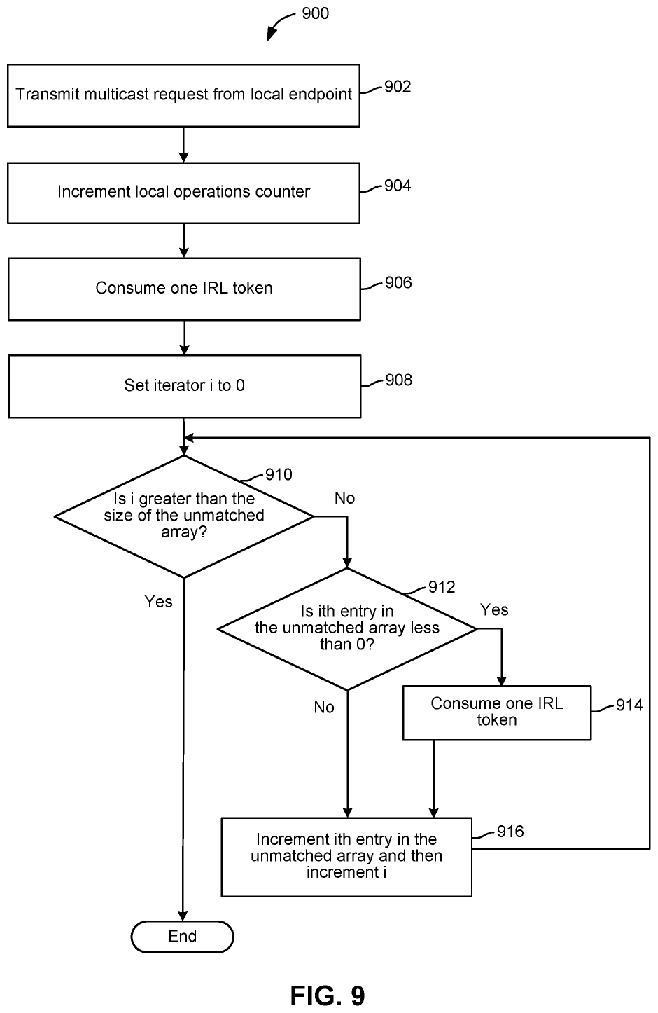

The local operations counter 318 is an integer used to track the number of outstanding local requests. Outstanding local requests are multicast requests from a local endpoint that have been transmitted to remote endpoints, but for which responses have not been received from the remote endpoints. In some embodiments, the IRL module 312 increments the value of the local operations counter 318 when the multicast requests are injected for transmission, and decrements the value of the local operations counter 318 when responses to previous requests are received. The local operations counter 318 is used to ensure that a “match” that consumes extra IRL tokens only occurs when requests are still in the network and can, therefore, cause network congestion if additional requests are transmitted at the same time. In some embodiments, no value in the unmatched array 316 is allowed to exceed the local operations counter 318 value, as discussed in greater detail below in conjunction with FIGS. 5 and 9.

The outstanding array 320 is used to track the number of outstanding requests a local endpoint believes that remote endpoints have outstanding in the network. In some embodiments, the outstanding array 320 can be implemented as an array of size N−1, where N is the number of endpoints in the system. The value of an entry in the outstanding array 320 associated with a particular remote endpoint is decremented, indicating an additional outstanding request, when the local endpoint receives a request from the particular remote endpoint. The value of the entry associated with a particular remote endpoint is incremented when the local endpoint believes the request from the particular remote endpoint has exited the network. In some embodiments, the local endpoint approximates how long remote requests are in the network based on observations of network round-trip times (RTTs), which can be measured using local transaction RTTs. No entry that is associated with a remote endpoint in the unmatched array 316 is allowed to have a value that is smaller than the value of a corresponding entry associated with the same remote endpoint in the outstanding array 320.

The remote operations queue 322 stores the expiration times of remote requests that local endpoints receive. When an endpoint receives a remote request, the endpoint can append an entry to the remote operations queue 322 that indicates the source endpoint associated with the remote request and an expiration time. The remote operation is assigned an expiration time based on the current observed RTT. When the remote operation expires, the local endpoint can increment an entry associated with the remote endpoint in the outstanding array 320. In some embodiments, the remote operation queue 322 can be implemented as a linked list of tuples that indicate the expiration times and source endpoints associated with remote requests.

As described, multicast communications can be used to implement collective operations that are performed by multiple processing units in parallel. In such cases, a collective operation generates traffic at every processing unit in a multicast group. Accordingly, if a processing unit receives a collective operation on a multicast group and is sending collective operations on the same multicast group, the processing unit can infer that there is contention on that multicast group, meaning that fewer packets should be sent. In some embodiments, the IRL module 312 implements a multicast congestion control technique that scales the number of IRL tokens 314 required to send a packet associated with a multicast request according to the number of concurrent senders on a multicast group.

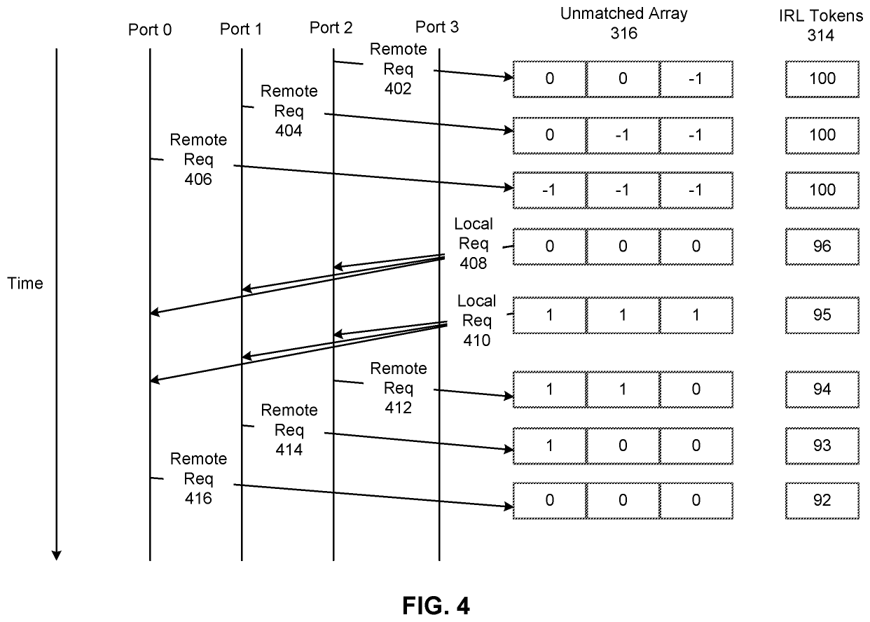

Conventionally, a request packet only consumes IRL tokens at a source endpoint. In some embodiments, to increase the IRL token cost of a multicast request, the multicast request also consumes IRL tokens at the destination endpoint when the destination endpoint receives the multicast request. Doing so allows endpoints to consume each other's IRL tokens. However, the manner in which endpoints consume each other's IRL tokens needs to be fair. For example, if endpoint A starts transmitting requests 10 microseconds before all other endpoints in the multicast group, then the requests of endpoint A will arrive first and consume all the IRL tokens of the endpoints in the multicast group, thereby preventing any other endpoint in the multicast group from transmitting a request. To avoid such a scenario, in some embodiments, endpoints only take each other's IRL tokens if the destination endpoint is also sending multicast requests, which is determined using the unmatched array 316, the local operations counter 318, the outstanding array 320, and the remote operations queue 322. These data structures are used to 1) match transmitted and received multicast traffic and 2) to avoid matching old and new traffic and therefore unnecessarily throttling transmission rates. For each data structure, the state for both request and response traffic can be maintained, but only one set is described herein in detail for simplicity because both share the same behavior. As described, the unmatched array 316 in particular tracks the amount of unmatched received or transmitted traffic in the granularity of requests. Whenever a packet associated with a multicast request is transmitted or received, the unmatched array 316 can be indexed to determine whether the packet should consume extra IRL tokens 314. In some embodiments, the unmatched array 316 can be incremented when multicast requests are transmitted and decremented when multicast requests are received, as described in greater detail below in conjunction with FIG. 4.

FIG. 4 illustrates how the unmatched array 316 and IRL tokens 314 of FIG. 3 are reduced, according to various embodiments. As shown, when a remote multicast request 402 from a remote endpoint, shown as port 2, to a local endpoint, shown as port 3, is received by the switch 110, the IRL module 312 changes a state of the unmatched array 316 by decrementing an entry associated with port 2 to −1. Although ports 1-3 are shown as reference examples in FIGS. 4-7B, techniques disclosed herein can be used with any technically feasible number and type of endpoints, such as GPUs and/or other parallel processing subsystems. Illustratively, 100 IRL tokens 316 are initially available for the port 3 to consume to transmit requests. In addition, when a remote multicast request 404 is received from port 1 and a remote multicast request 406 is received from port 0, the IRL module 312 decrements corresponding entries in the unmatched array 316 that are associated with port 1 and port 0 to −1. The entries being decremented to −1 indicates that the three ports 0, 1, and 2 are transmitting packets at the same time. Notably, no IRL tokens 314 are consumed because the values of the entries in the unmatched array 314 are 0 or negative.

Illustratively, when port 3 transmits a local multicast request 408, the IRL module 312 (1) causes four IRL tokens 314 to be consumed, leaving 96 IRL tokens, and (2) increments each of the unmatched array entries associated with ports 0, 1, and 2 by 1, such that the entry values become 0. One token is consumed because the local multicast request 408 is being sent. Three tokens are consumed because three entries in the unmatched array 316 are less than 0. Because a source requires IRL tokens to inject a packet, consuming additional IRL tokens due to remote multicast operations throttles the source's ability to inject requests.

After the four IRL tokens 314 are consumed, and the unmatched array entries are incremented by 1 to 0, when port 3 transmits another local request 410 to the ports 0, 1, and 2, the IRL module 312 (1) causes one IRL token 314 to be consumed, leaving 95 IRL tokens; and (2) again increments each of the unmatched array 316 entries associated with ports 0, 1, and 2, to which the requests were sent, by 1, such that the entry values become 1. Only one IRL token 314 is consumed, because it is assumed, based on the entry values in the unmatched array 316, that no other endpoints are transmitting requests. When remote multicast requests 412, 414, and 416 are later received from port 2, port 1, and port 0, respectively, the IRL module 312 again decrements the associated entries in the unmatched array 314. Illustratively, the values of the entries associated with port 2, port 1, and port 0 are decremented from 1 to 0. In addition, because the values of the entries were being decremented from 1, which is positive, an IRL token 316 is consumed each time the multicast requests 412, 414, and 416 are received. Again, this is the desired result in order to avoid network congestion because other endpoints are transmitting requests at the same time.

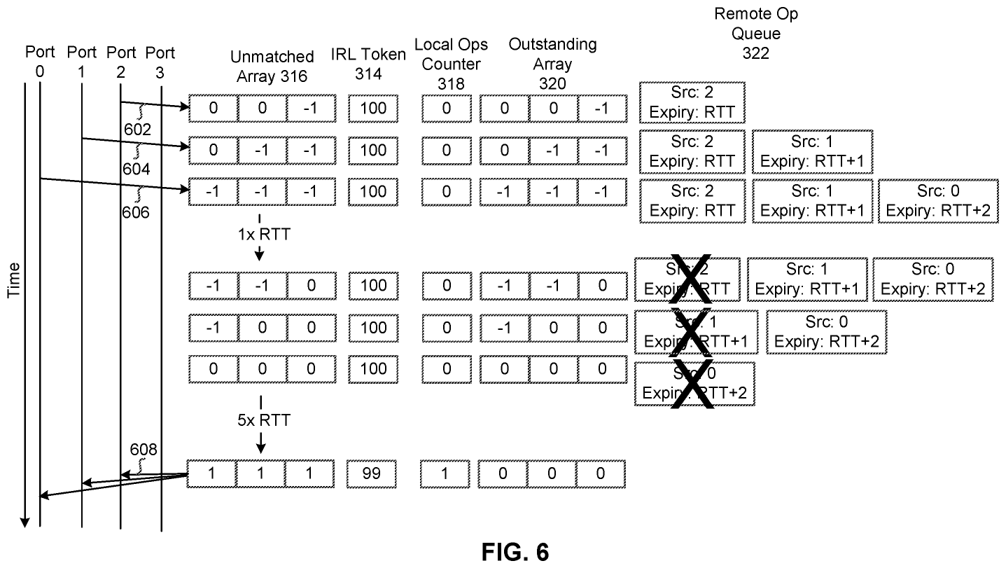

The approach for consuming IRL tokens illustrated in FIG. 4 works well if ports 0-3 all send multicast requests around the same time. However, after a certain amount of time, the unmatched array 316 may include stale information because enough time has passed that the local and remote traffic no longer contend for bandwidth. In some embodiments, to avoid keeping stale information in the unmatched array 316, the local operations counter 318 and the outstanding array 320 are used to track the maximum possible unmatched requests, as described in greater detail below in conjunction with FIGS. 5-6. In such cases, multicast requests are unmatchable when the packets corresponding to the multicast requests are no longer in the network. The outstanding array 320 decrements when remote requests arrive and increments over time based on network congestion. The local operations counter 318 increments when a local endpoint transmits a multicast request and decrements when the local endpoint receives a response to a multicast request.

FIG. 5 illustrates how the unmatched array 316, the IRL tokens 314, and the local operations counter 318 of FIG. 3 are reduced, according to various embodiments. As shown, in addition to the behavior of incrementing and decrementing entries associated with remote endpoints in the unmatched array 316 and consuming IRL tokens 314, which is similar to the description above in conjunction with FIG. 4, in some embodiments, local ports such as port 3 also (1) increment the value of the local operations counter 318 when those endpoints inject multicast requests for transmission, and (2) decrement the value of the local operations counter 318 when a response to a previous request is received. As described, the local operations counter 318 is used to ensure that a “match” that consumes extra IRL tokens only occurs when requests are still in the network and can, therefore, cause network congestion if additional requests are transmitted at the same time.

In some embodiments, no value in the unmatched array 316 is allowed to exceed the local operations counter 318 value at the current time. Illustratively, when port 3 transmits local multicast requests 508 and 510, port 3 increments the local operations counter 318 to 1 and 2, respectively. Then, when port 3 receives responses 512 and 516, port 3 decrements the local operations counter 318 to 1 and 0, respectively. Further, values of entries in the unmatched array 316 are less than the value of the local operations counter 318 at every point in time. For example, after multicast responses 512 and 516 are received from ports 1, 2, and 3, the local operations counter 318 is decremented to 1 and 0, respectively. In addition, the IRL module ensures that 312 that none of the entries of the unmatched array 314 are greater than the value of the local operations counter, namely 1 and 0, at those times. In particular, after the endpoint receives the multicast response 516, the entries of the unmatched array are set to 0 because the local operations counter 318 value is 0. Then, when new remote requests 518 and 520 arrive, the remote requests 518 and 520 no longer match with previous local requests and, therefore, do not consume IRL tokens 316. This is the desired behavior because remote requests should not be matching with old local requests that are no longer in the network.

The opposite issue can also occur, namely old remote requests may match with new local requests. The remote operations queue 322 and the outstanding array 320 are used to resolve such issues, as described in greater detail below in conjunction with FIG. 6. The IRL module 312 maintains the outstanding array 320 to track the number of received requests from each remote host, and the value of an entry in the unmatched array 316 must be greater than or equal to the corresponding entry in the outstanding array 320. Meta data can also be stored about received requests in the remote operations queue 322. The IRL module 312 removes entries from the remote operations queue 322 over time, and then increments the outstanding array 320, which reduces the chance of a spurious match between local and remote requests. In some embodiments, local RTT measurements made via multicast packet RTTs, such as the RTTs of probe packets, are used to determine how long a request is held in the remote operations queue 322. However, only incorporating RTT can be insufficient, so how long a packet waits at the head of a transmission queue can also be used in some embodiments. In such cases, meta data can remain in the remote operations queue 322 for an RTT plus the delay between packets sent.

FIG. 6 illustrates how the unmatched array 316, the IRL tokens 314, the local operations counter 318, the outstanding array 320, and the remote operations queue 322 of FIG. 3 are reduced, according to various embodiments. As shown, in addition to the behaviors of (1) incrementing and decrementing entries associated with remote endpoints in the unmatched array 314 and consuming IRL tokens 316, and (2) incrementing and decrementing the local operations counter 318, which are similar to the descriptions above in conjunction with FIGS. 4 and 5, respectively, in some embodiments, local endpoints that receive a request from a remote endpoint also (1) decrement the value of an entry in the outstanding array 320 associated with that remote endpoint, and (2) add an entry to the remote operations queue 322 that indicates the source endpoint associated with the remote request and an expiration time that is based on the current observed RTT, and specifically the RTT plus the delay between packets sent. The local endpoint can later increment the value of the entry associated with a remote endpoint when the expiration time passes and, therefore, the local endpoint believes that the request from the remote endpoint has exited the network. In addition, no entry that is associated with a remote endpoint in the unmatched array 316 is allowed to have a value that is smaller than the value of a corresponding entry associated with the same remote endpoint in the outstanding array 320.

Illustratively, when port 3 receives multicast requests 602, 604, and 606 from port 2, port 1, and port 0, respectively, port 3 decrements the value of an entry in the outstanding array 320 associated with port 2, port 1, and port 0, respectively, to −1.

In addition, for each of the received requests 602, 604, and 606, the port 3 appends an entry to the remote operations queue 322 that indicates (1) the port 2, 1, and 0 associated with the request 602, 604, and 606, respectively; and (2) an expiration time that is the current RTT plus the delay between packets sent. Illustratively, port 3 later increments the value of the entries in the outstanding array 320 associated with port 2, port 1, and port 0 when the associated entries in the remote operations queue 322 expire. Illustratively, when the entry associated with port 2 expires, the entry associated with port 2 in the outstanding array 320 is incremented from −1 to 0. Then, when the entry associated with port 1 expires, the entry associated with port 1 in the outstanding array 320 is incremented from −1 to 0. Similarly, when the entry associated with port 0 expires, the entry associated with port 0 in the outstanding array 320 is incremented from −1 to 0. In addition, the IRL module 312 ensures that no entry that is associated with a remote endpoint in the unmatched array 316 has a value that is smaller than the value of a corresponding entry associated with the same remote endpoint in the outstanding array 320.

By tracking information about remote requests, the IRL module 312 can avoid matching two requests that do not contend for bandwidth. As described, remote requests are removed from the remote operations queue 322 when the current clock hits the arrival time of the request plus the sum of the currently observed network RTT and the delay between sending multicast packets. As remote requests are removed from the remote operations queue 322, corresponding entries in the outstanding array 322 are incremented and entries in the unmatched array 316 are also incremented if unmatched[source] is less than outstanding[source].

Experience has shown that the multicast congestion control described in conjunction with FIG. 6 works relatively well at managing congestion but can leave the network slightly underutilized. In some embodiments, to mitigate network underutilization and increase throughput, a multiplicative increase can be used that reduces the number of IRL taken by remote request operations. In such cases, if the measured latency of a collective operation is less than a latency threshold (e.g., a given number of cycles), remote operations only take a fraction of the number of tokens that remote operations normally consume. Doing so can improve the network throughput.

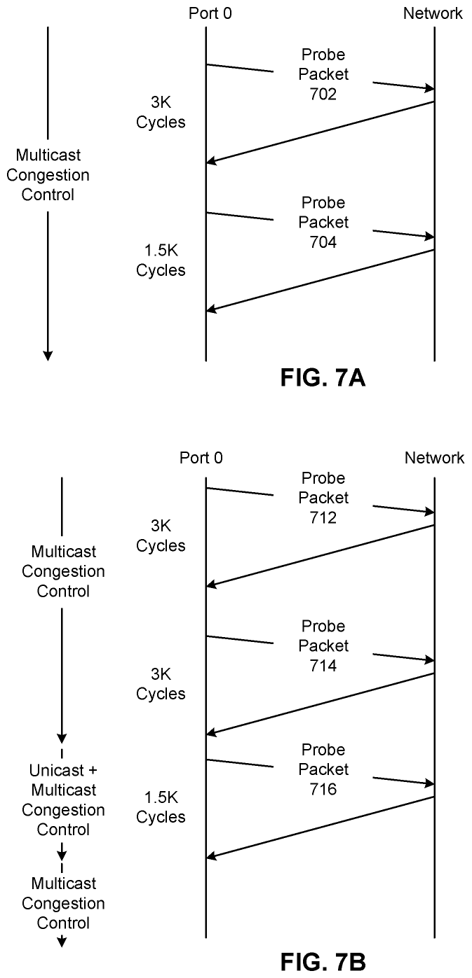

FIG. 7A illustrates how network congestion is managed using multicast congestion control, according to various embodiments. As shown, the round-trip time for a first probe packet 702 that is transmitted by port 0 is 3 thousand cycles, and the round-trip time (RTT) for a second probe packet 704 that is transmitted by port 0 is 1.5 thousand cycles. In some embodiments, in addition to the multicast congestion control described above in conjunction with FIGS. 4-6, the IRL module 312 also performs unicast congestion control when the unicast congestion control would throttle multicast requests more than the multicast congestion control. Rather than consuming more IRL tokens as in the case of multicast congestion control, the unicast congestion control increases the cost of transmitting requests by lowering a watermark that is used to control the number of IRL tokens produced over a given time period.

In some embodiments, subsequent to performing the multicast congestion control technique described above in conjunction with FIGS. 4-6, the IRL module 312 (1) computes a unicast equivalent of the multicast congestion control, and (2) performs unicast congestion control, in addition to the multicast congestion control, by lowering the watermark if the unicast congestion control would throttle multicast requests more than the multicast congestion control technique. However, during startup, congestion may be inevitable when the multicast congestion control technique takes time to reduce congestion, and the watermark is not reduced during such a time period in some embodiments.

As described, the IRL module 312 initially performs the multicast congestion control technique, and then also performs the unicast congestion control technique by lowering the watermark if the unicast congestion control technique would throttle multicast requests more than the multicast congestion control technique. To determine which congestion control technique throttles more, the IRL module 312 converts between the multicast congestion control and the unicast congestion control by computing a unicast equivalent of the multicast congestion control. In some embodiments, the unicast equivalent of the multicast congestion control can be computed as:

$$X = ( WM\_MAX * N ) / L . \qquad ( 1 )$$

In equation (1), X is the reduction in the watermark that would have given the same injection rate throttling as the multicast congestion control, L (latency) is the RTT of a probe packet, N is the number of tokens consumed using the multicast congestion control technique over the time period L, and WM_MAX is a maximum watermark value. Equation (1) can be derived as follows. First, the number of tokens that a port likely generated over the last RTT can be determined using the current watermark:

$$L * ( watermark / WM\_MAX ) . \qquad ( 2 )$$

This assumes that L is measured in cycles, and each cycle there is a watermark/WM_MAX probability of producing a token. Then, a second expression can be created that determines how many tokens would be produced over L if the watermark were lowered by X:

$$L * ( ( watermark - X ) / WM\_MAX ) . \qquad ( 3 )$$

The expressions in equations (2) and (3) can be subtracted and set equal to the tokens consumed by the multicast congestion control (N):

$$N = L * \frac{watermark}{WM\_MAX} - L * \frac{( watermark - X )}{WM\_MAX} , \qquad ( 4 )$$

Equation (4) simplifies to equation (1).

The IRL module 312 can use the unicast equivalent of the multicast congestion control, computed according to equation (1), to determine whether the watermark needs to be reduced. Specifically, in some embodiments, the RTT of a probe packet is used as a proxy for the amount of congestion in the network. If the RTT indicates that there is no network congestion (e.g., if the RTT is less than a latency threshold), then the IRL module 312 performs an additive increase of the watermark. On the other hand, if the RTT indicates that there is network congestion (e.g., if the RTT is not less than a latency threshold), then the IRL module 312 computes the reduction in the watermark X that is the unicast equivalent of the multicast congestion control according to equation (1). As shown in FIG. 7A, when the latency is 3000 cycles and the number of tokens consumed using multicast congestion control and a maximum watermark are known, the IRL module 312 can solve for the equivalent reduction in the watermark X for according to equation (1). The reduction in the watermark X can then be compared with a baseline constant reduction in the watermark that is referred to herein as the multiplicative decrease (MD). In some embodiments, the MD can be scaled based on the network congestion, such that the watermark is decreased more as the network congestion increases. If the throttling according to the multicast congestion control technique is not less than the throttling that would occur if the watermark were decreased by the MD, then the IRL module 312 continues performing the multicast congestion control technique. On the other hand, if the throttling according to the multicast congestion control is less than the throttling that would occur if the watermark were decreased by the MD, then the IRL module 312 decreases the watermark by the MD.

In the example of FIG. 7A, the throttling according to the multicast congestion control technique is not less than the throttling that would occur if the watermark were decreased by the MD, meaning that the network congestion can potentially be resolved exclusively by the multicast congestion control technique. In such a case, the IRL module 312 does not reduce the watermark by the MD. Instead, the IRL module 312 waits to see if the network congestion is alleviated with just the multicast congestion control technique. It should be noted that reducing the watermark in such a case would result in a loss of throughput.

FIG. 7B illustrates how network congestion is managed using multicast congestion control and unicast congestion control, according to various embodiments. As shown, the round-trip time for a first probe packet 712 that is transmitted by port 0 is 3 thousand cycles, the round-trip time for a second probe packet 714 that is transmitted by port 0 is 3 thousand cycles, and the round-trip time for a third probe packet 716 that is transmitted by port 0 is 1.5 thousand cycles. In the example of FIG. 7B, assume that after the first probe packet 712 returns, the IRL module 312 determines that the throttling according to the multicast congestion control technique is not less than the throttling that would occur if the watermark were decreased by the MD, meaning that the network congestion can potentially be resolved exclusively by the multicast congestion control. Accordingly, the IRL module 312 waits to see if the network congestion is alleviated with just the multicast congestion control technique. However, after the second probe packet 714 returns, the IRL module 312 determines that the throttling according to the multicast congestion control technique is less than the throttling that would occur if the watermark were decreased by the MD, meaning that the network congestion cannot be resolved exclusively by the multicast congestion control technique. In response, the IRL module 312 performs a unicast congestion control technique in which the watermark is reduced by the MD in addition to the multicast congestion control technique. In the example of FIG. 7B, after the third probe packet 716 returns, the IRL module 312 determines based on the RTT of the third probe packet 716 that the network congestion has been resolved. In response, the IRL module 312 can additively increase the watermark.

In some embodiments, the IRL module 312 can adjust the watermark based on probe packet delay and a multicast congestion control technique according to Algorithm 1:

| Algorithm 1 Protocol when Probe Packet Arrives | |
|---|---|
| 1: | $md\_scaling = \frac{packet\_lat - lat\_thresh}{max\_lat \_thresh - lat\_thresh} * base\_md$ |
| 2: | md = 1 − max(1 − md_scaling, base_md) |
| 3: | if RTT Finished then |
| 4: | $percent\_mcast \_writes = \frac{sent\_mcast \_writes}{sent\_mcast \_total}$ |
| 5: | if percent_writes ≤ .5 then |
| 6: | size_diff = write_size − write_ack |
| 7: | scaling_fact = (2 * (1 − percent_writes) − 1) |
| 8: | global_dec + = size_diff * global_dec * scaling_fact |
| 9: | end if |
| 10: | global_dec + = carry_over |
| 11: | $wm\_eq = \frac{WM\_MAX * global\_dec}{packet\_lat}$ |
| 12: | max_possible = wm/WM_MAX * packet_lat |
| 13: | if wm_eq > last_wm_eq then |
| 14: | wm_Δ = wm_eq − last_wm_eq |
| 15: | wm = min(wm + wm_Δ, WM_MAX) |
| 16: | if (packet_lat > lat_thresh && wm_Δ < wm * md) then |
| 17: | fbs = max(1 − (α/\sqrt{wm − wm_eq} − β), .05) |
| 18: | wm = wm − fbs * md * (wm − wm_eq) |
| 19: | end if |
| 20: | else if packet_lat > lat_thresh then |
| 21: | fbs = max((1 − (α/\sqrt{wm − wm_eq} − β), .05) |
| 22: | wm = wm − fbs * md * (wm − wm_eq) |
| 23: | end if |
| 24: | last_wm_eq = wm_eq |
| 25: | carry_over = calculate_carry_over( ) |
| 26: | global_dec = 0 |
| 27: | send_mcast_writes = 0 |
| 28: | sent_total = 0 |
| 29: | if packet_lat < lat_thresh then |
| 30: | wm = min(wm + WM_AI, WM_MAX) |
| 31: | end if |
| 32: | wm = min(max(wm, WM_MIN), WM_MAX) |
| 33: | end if |

In Algorithm 1, Line 1 determines the multiplicative decrease, which is a linear function from 1 to base_md based on the latency. The larger the latency, the larger the decrease. Note, a lower md indicates a larger watermark decrease. Line 3 ensures that a probe packet has been received. Lines 4-9 scale the request tokens decremented (global_dec) based on the percentage of multicast operations that were writes. Without scaling the credits, the watermark may be incorrectly reduced for the minority type of traffic. For example, suppose read dominate workload is being handled, such that response IRL tokens are mostly being consumed, while few request IRL tokens are consumed. When the conversion from consumed request tokens to a watermark equivalent is performed, a low watermark will be calculated, which indicates the protocol did not throttle packets, and the request watermark should be lowered. However, this is not necessarily true. The request watermark equivalent is only small because few writes were transmitted. To prevent the request watermark from being unnecessarily lowered, the watermark equivalent can be increased based on how skewed the workload is. Line 11 calculates the watermark equivalent, and Line 12 calculates the maximum possible tokens produced over the last RTT. Line 13 checks to see if the watermark equivalent grew over the last RTT. If the watermark equivalent did grow, Line 14 checks the change in watermark equivalent. If the network is congested and the change in watermark equivalent is less than the potential MD, then the MD is scaled based on the current watermark and watermark equivalent. The watermark is then decreased. In some embodiments, a flow-based scaling (FBS) technique can be used with two parameters, a and B, which are set according to the following equations:

$$α = \frac{1}{\frac{1}{\sqrt{WM\_MIN}} - \frac{1}{\sqrt{WM\_MAX}}} , β = \frac{α}{\sqrt{WM\_MAX}} . \qquad ( 5 )$$

On lines 20-22, the watermark is decreased if the watermark equivalent shrunk over the last RTT and the network is congested. Lines 24-28 update the state for the next RTT. On lines 29-31, an additive increase is performed if there is no network congestion. Line 32 ensures the watermark is in bounds.

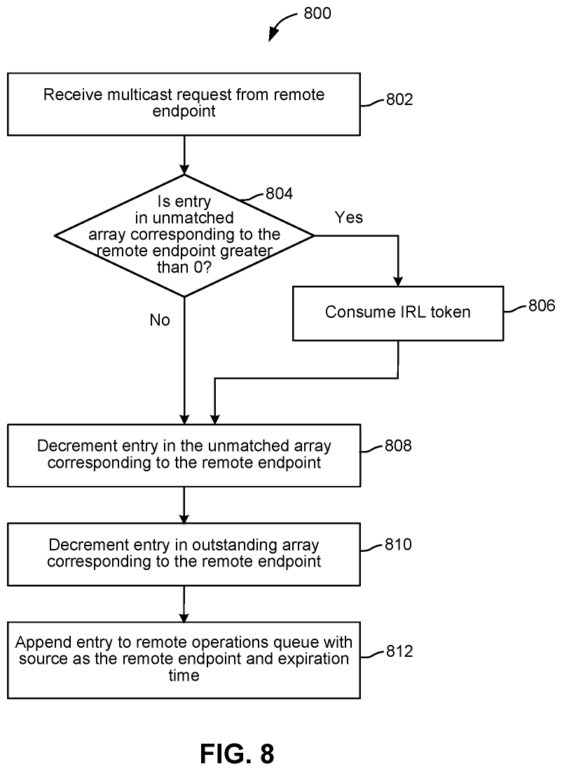

FIG. 8 is a flow diagram of method steps for updating switch data structures in response to receiving a multicast request, according to various embodiments. Although the method steps are described in conjunction with the system of FIGS. 1-3, persons of ordinary skill in the art will understand that any system configured to perform the method steps, in any order, is within the scope of the present disclosure.

As shown, a method 800 begins at step 802, where the switch 110 receives a multicast request from a remote endpoint.

At step 804, the IRL module 312 determines whether an entry in the unmatched array 316 corresponding to the remote endpoint is greater than 0. If the entry in the unmatched array 316 corresponding to the remote endpoint is greater than 0, then at step 806, the IRL module 312 causes an IRL token to be consumed. Although described with respect to one IRL, multiple IRL tokens can be consumed in some embodiments. Although the methods 800, 900, 1000, 1100, and 1200 of FIGS. 8-12 are described with respect to the IRL tokens 314, the unmatched array 316, the local operations counter 318, the outstanding array 320, and the remote operations queue 322 as reference examples of data structures, in some embodiments, steps of the methods 800, 900, 1000, 1100, and 1200 can be modified for use with any technically feasible data structures to determine the congestion state of a network based on received data associated with multicast operations, and an amount of data that is transmitted can then be reduced based on the congestion state of the network.

After the IRL token is consumed at step 806, or if the IRL module 312 determines at step 804 that the entry in the unmatched array 316 corresponding to the remote endpoint is not greater than 0, then at step 808, the IRL module 312 decrements the entry in the unmatched array 316 corresponding to the remote endpoint.

At step 810, the IRL module 312 decrements an entry in outstanding array 320 corresponding to the remote endpoint. In addition, at step 812, the IRL module 312 appends an entry to the remote operations queue 322. The entry that is appended to the remote operations queue 322 includes a source set to the remote endpoint and an expiration time, which as described can be the RTT plus the delay between packets sent in some embodiments.

FIG. 9 is a flow diagram of method steps for updating switch data structures when transmitting a multicast request, according to various embodiments. Although the method steps are described in conjunction with the system of FIGS. 1-3, persons of ordinary skill in the art will understand that any system configured to perform the method steps, in any order, is within the scope of the present disclosure.

As shown, a method 900 begins at step 902, where the switch 110 transmits a multicast request from a local endpoint.

At step 904, the IRL module 312 increments the local operations counter 318. The local operations counter 318 is incremented because the multicast request from the local endpoint was transmitted at step 902 and a response has not yet been received, meaning that there is network traffic due to the multicast request from the local endpoint.

At step 906, the IRL module 312 consumes one IRL token because the multicast request was transmitted from the local endpoint.

At step 908, the IRL module 312 sets the value of an iterator i, which is used to iterate through the unmatched array 316, to 0. In some other embodiments, the iterator i can be set to any other suitable pointer to a first entry in the unmatched array 316.

At step 910, the IRL module 312 enters a loop in which the IRL module 312 determines whether the value of i is greater than the size of the unmatched array 316. If the IRL module 312 determines at step 910 that the value of i is greater than the size of the unmatched array 316, then the method 900 ends.

On the other hand, if the IRL module 312 determines that the value of i is not less than the size of the unmatched array 316, then at step 912, the IRL module 312 determines whether the ith entry in the unmatched array 316 is less than 0.

If the IRL module 312 determines at step 912 that the value of the ith entry in the unmatched array 316 is not less than 0, then at step 914, the IRL module 312 causes another IRL token to be consumed. Another IRL token is consumed because the value of the ith entry in the unmatched array 316 being not less than 0 indicates that one or more multicast requests were transmitted from the local endpoint to a remote endpoint associated with the ith entry of the unmatched array 316, and no response has been received from the unmatched array 316 that decremented the ith entry again, meaning that the multicast requests are still outstanding in the network.

After step 914, or if the IRL module 312 determines at step 912 determines that the ith entry in the unmatched array 316 is less than 0, then at step 916, the IRL module 312 (1) increments the ith entry in the unmatched array 316, and then (2) increments the iterator i. Then, the method 900 returns to step 910, where the looping continues until i is greater than the size of the unmatched array.

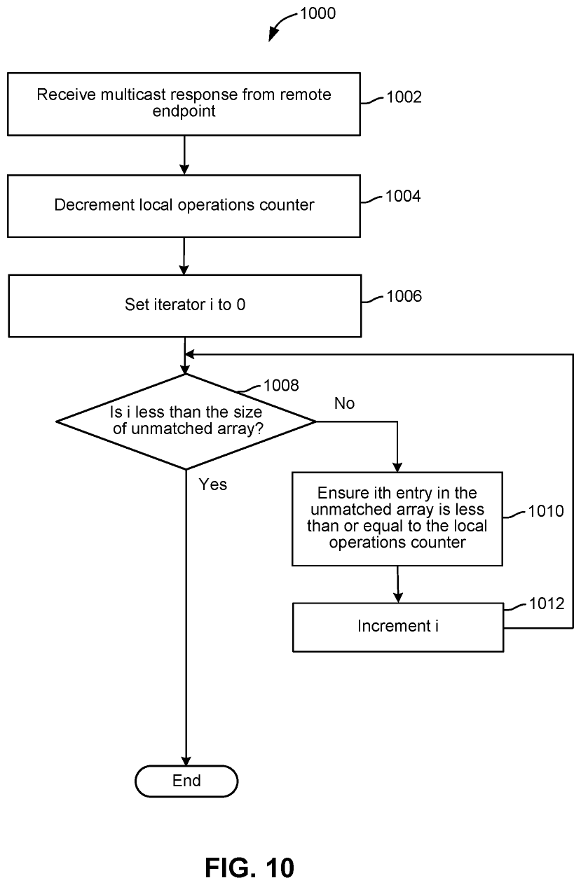

FIG. 10 is a flow diagram of method steps for updating switch data structures in response to receiving a multicast response, according to various embodiments. Although the method steps are described in conjunction with the system of FIGS. 1-3, persons of ordinary skill in the art will understand that any system configured to perform the method steps, in any order, is within the scope of the present disclosure.

As shown, a method 1000 begins at step 1002, where the switch 110 receives a multicast response from a remote endpoint.

At step 1004, the IRL module 312 decrements the local operations counter 318. The local operations counter is decremented because the multicast request associated with the received multicast response is no longer outstanding in the network.

At step 1006, the IRL module 312 sets the value of an iterator i, which is used to iterate through the unmatched array 316, to 0. In some other embodiments, the iterator i can be set to any other suitable pointer to a first entry in the unmatched array 316.

At step 1008, the IRL module 312 enters a loop in which the IRL module 312 determines whether the value of i is greater than the size of the unmatched array 316. If i is less than the size of the unmatched array 316, then the method 1000 ends.

On the other hand, if i is not less than the size of the unmatched array 316, then at step 1010, the IRL module 312 ensures that ith entry in the unmatched array 316 is less than or equal to the local operations counter. In some embodiments, the IRL module 312 can ensure that ith entry in the unmatched array 316 is less than or equal to the local operations counter by setting the ith entry in the unmatched array 316 to the minimum of the ith entry and the local operations counter. As described, the IRL module 312 ensures that entries in the unmatched array 316 are less than or equal to the local operations counter because remote requests should not be matching with old local requests that are no longer in the network.

At step 1012, the IRL module 312 increments the value of the iterator i. Then, the method 1000 returns to step 1008, where the looping continues until i is greater than the size of the unmatched array 316.

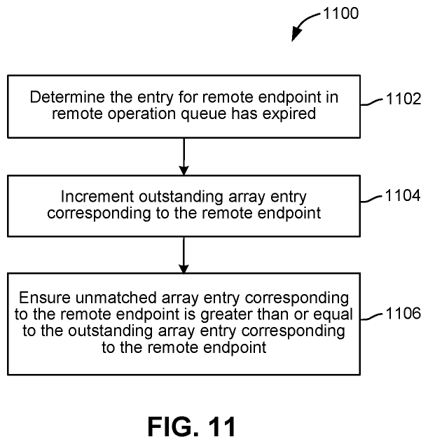

FIG. 11 is a flow diagram of method steps for ensuring that entries in the unmatched array 316 are greater than or equal to corresponding entries in the outstanding array 320, according to various embodiments. Although the method steps are described in conjunction with the system of FIGS. 1-3, persons of ordinary skill in the art will understand that any system configured to perform the method steps, in any order, is within the scope of the present disclosure.

As shown, a method 1100 begins at step 1102, where the IRL module 312 determines that the entry for a remote endpoint in the remote operation queue 322 has expired.

At step 1104, the IRL module 312 increments an entry in the outstanding array 320 corresponding to the same remote endpoint for which the entry in the remote operation queue 322 has expired.

At step 1106, the IRL module 312 ensures that an entry in the unmatched array 316 corresponding to the remote endpoint is greater than or equal to the entry in the outstanding array 320 corresponding to the remote endpoint. In some embodiments, the IRL module 312 can ensure that the entry in the unmatched array 316 corresponding to the remote endpoint is greater than or equal to the entry in the outstanding array 320 corresponding to the remote endpoint by setting the entry in the unmatched array 316 corresponding to the remote endpoint to a maximum of the same entry in the unmatched array 316 and the entry in the outstanding array 320 corresponding to the remote endpoint. As described, by tracking information about remote requests using the outstanding array 320 and ensuring that entries in the unmatched array 316 are greater than or equal to corresponding entries in the outstanding array 320, the IRL module 312 can avoid matching requests that do not contend for bandwidth

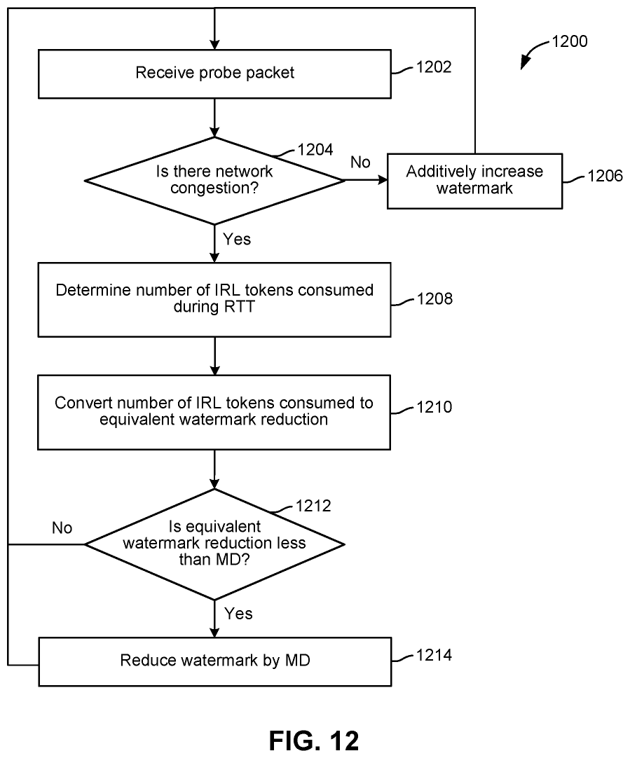

FIG. 12 is a flow diagram of method steps for performing unicast congestion control along with multicast congestion control, according to various embodiments. Although the method steps are described in conjunction with the system of FIGS. 1-3, persons of ordinary skill in the art will understand that any system configured to perform the method steps, in any order, is within the scope of the present disclosure.

As shown, a method 1200 begins at step 1202, where the L1 switch 110 receives a probe packet.

At step 1204, the IRL module 312 determines whether there is network congestion. In some embodiments, the RTT of the probe packet received at step 1202 is used as a proxy for the amount of congestion in the network. In such cases, the IRL module 312 can determine that there is network congestion if the RTT of the probe packet is greater than a latency threshold.

If there is no network congestion, then at step 1206, the IRL module 312 performs an additive increase to the watermark that is used to control the number of IRL tokens produced over a given time period. The method then returns to step 1202, where the IRL module 312 waits for another probe packet to be received.

On the other hand, if there is network congestion, then the method 1200 continues to step 1208, where the IRL module 312 determines a number of IRL tokens consumed during the RTT of the probe packet. In some embodiments, the IRL module 312 can track the IRL tokens that are being consumed.

At step 1210, the IRL module 312 converts the number of IRL tokens consumed to an equivalent watermark reduction. In some embodiments, the IRL module 312 can convert the number of IRL tokens consumed to the equivalent watermark reduction according to equation (1), described above in conjunction with FIG. 7A.

At step 1212, the IRL module 312 determines whether the equivalent watermark reduction is less than an MD. As described, the MD is a baseline constant reduction in the watermark and, in some embodiments, the MD can be scaled based on the network congestion, such that the watermark is decreased more as the network congestion increases.

If the equivalent watermark reduction is not less than the MD, then the method 1200 returns to step 1202, where the IRL module 312 waits for another probe packet to be received.

On the other hand, if the equivalent watermark reduction is less than the MD, then the method 1200 continues to step 1214, where the IRL module 312 reduces the watermark by the MD. In some embodiments, the IRL 312 continues performing the multicast congestion control after the watermark is reduced. In some other embodiments, the IRL module 312 stops performing multicast congestion control until the network congestion subsides. The method 1200 then returns to step 1202, where the IRL module 312 waits for another probe packet to be received.

In sum, techniques are disclosed for reducing network congestion due to multicast communications. In some embodiments, an L1 switch determines the congestion state of a network based on received data associated with multicast operations, and the L1 switch reduces an amount of data that is transmitted based on the congestion state of the network. In particular, in some embodiments, when the L1 switch receives multicast requests from remote endpoints, the L1 switch decrements entries in an unmatched array that are associated with the remote endpoints. Then, when a local endpoint transmits a multicast request, the L1 switch (1) increments the entries in the unmatched array, and (2) decreases the number of IRL tokens available for the local endpoint to transmit requests based on the transmission of the multicast request and the entries in the unmatched array. In some embodiments, the L1 switch also (1) decrements entries in an outstanding operations array that are associated with remote endpoints when multicast requests are received from the remote endpoints, and (2) adds an entry to a remote operations queue that indicates expiration times of the received multicast requests. When the expiration times elapse, the entries in the outstanding operations array that are associated with the remote endpoints are incremented, and corresponding entries in the unmatched array are set equal to the entries in the outstanding operations array if the corresponding entries are smaller than the entries in the outstanding operations array. In addition, in some embodiments, the L1 switch computes a reduction to a watermark that is equivalent to a number of tokens consumed over a period of time due to the multicast network congestion management, and, if the reduction to the watermark is less than a baseline constant amount, then the L1 switch performs unicast congestion control by reducing the watermark by the baseline constant amount.

At least one technical advantage of the disclosed techniques relative to the prior art is that the disclosed techniques can more effectively reduce network congestion caused by multicast communications. In this regard, the disclosed techniques can more quickly reduce the packet transmission delays and packet losses oftentimes experienced when multicast communications cause network congestion. In addition, the disclosed techniques do not cause much, if any, loss of network throughput when implemented to reduce the network congestion caused by multicast communications. These technical advantages represent one or more technological improvements over prior art approaches.
1. In some embodiments, a computer-implemented method for reducing network congestion caused by multicast communications comprises receiving, via a network, first data associated with one or more multicast operations, determining a congestion state of the network based on the first data, and performing one or more operations to reduce an amount of second data that is transmitted via the network based on the congestion state of the network.
2. The computer-implemented method of clause 1, wherein performing the one or more operations to reduce the amount of second data that is transmitted comprises reducing a number of tokens that permit data to be transmitted based on the congestion state of the network.
3. The computer-implemented method of clauses 1 or 2, further comprising computing a reduction to a watermark based on a number of tokens consumed over a period of time, wherein the tokens that permit data to be transmitted are generated based on the watermark, and responsive to determining that the reduction to the watermark is less than a constant value, reducing the watermark by the constant value.
4. The computer-implemented method of any of clauses 1-3, further comprising, when the second data is being transmitted, reducing the number of tokens based on the second data.
5. The computer-implemented method of any of clauses 1-4, wherein determining the congestion state of the network comprises updating, based on the first data, one or more entries in a first data structure, wherein each entry included in the one or more entries is associated with a respective remote endpoint.
6. The computer-implemented method of any of clauses 1-5, wherein updating the one or more entries in the first data structure comprises decrementing or incrementing the one or more entries to indicate that the one or more multicast operations are contributing to network congestion.
7. The computer-implemented method of any of clauses 1-6, further comprising, when the second data is being transmitted, incrementing or decrementing the one or more entries in the first data structure.
8. The computer-implemented method of any of clauses 1-7, further comprising updating, based on the second data, one or more entries in a second data structure that indicates outstanding data from one or more remote endpoints, wherein each entry included in the one or more entries in the second data structure is associated with a respective remote endpoint, and updating the one or more entries in the first data structure based on the one or more entries in the second data structure.
9. The computer-implemented method of any of clauses 1-8, further comprising storing, in a second data structure, one or more expiration times associated with the first data, and in response to the one or more expiration times elapsing, updating, based on the lapsing of the one or more expiration times, one or more entries in the first data structure to indicate that the first data no longer contributes to network congestion.
10. The computer-implemented method of any of clauses 1-9, further comprising computing the one or more expiration times based on when the first data was received, a round trip time, and a delay between data being sent.
11. The computer-implemented method of any of clauses 1-10, further comprising storing, in a second data structure, one or more indications of the first data being outstanding, and updating at least one entry in the first data structure based on the one or more indications of the first data being outstanding.
12. In some embodiments, one or more non-transitory computer-readable media store instructions that, when executed by at least one processor, cause the at least one processor to perform steps for reducing network congestion, the steps comprising receiving, via a network, first data associated with one or more multicast operations, determining a congestion state of the network based on the first data, and performing one or more operations to reduce an amount of second data that is transmitted via the network based on the congestion state of the network.
13. The one or more non-transitory computer-readable media of clause 12, wherein performing the one or more operations to reduce the amount of second data that is transmitted comprises reducing a number of tokens that permit data to be transmitted based on the congestion state of the network.
14. The one or more non-transitory computer-readable media of clauses 12 or 13, wherein the instructions, when executed by the at least one processor, further cause the at least one processor to perform the steps of computing a reduction to a watermark based on a number of tokens consumed over a period of time, wherein the tokens that permit data to be transmitted are generated based on the watermark, and responsive to determining that the reduction to the watermark is less than a constant value, reducing the watermark by the constant value.
15. The one or more non-transitory computer-readable media of any of clauses 12-14, wherein determining the congestion state of the network comprises updating, based on the first data, one or more entries in a first data structure, wherein each entry included in the one or more entries is associated with a respective remote endpoint.
16. The one or more non-transitory computer-readable media of any of clauses 12-15, wherein updating the one or more entries in the first data structure comprises decrementing the one or more entries to indicate that the one or more multicast operations are contributing to network congestion, and the instructions, when executed by the at least one processor, further cause the at least one processor to perform the step of when the second data is being transmitted, incrementing the one or more entries in the first data structure.
17. The one or more non-transitory computer-readable media of any of clauses 12-16, wherein the instructions, when executed by the at least one processor, further cause the at least one processor to perform the steps of updating, based on the second data, one or more entries in a second data structure that indicates outstanding data from one or more remote endpoints, wherein each entry included in the one or more entries in the second data structure is associated with a respective remote endpoint, and updating the one or more entries in the first data structure based on the one or more entries in the second data structure.
18. The one or more non-transitory computer-readable media of any of clauses 12-17, wherein the instructions, when executed by the at least one processor, further cause the at least one processor to perform the steps of storing, in a second data structure, one or more expiration times associated with the first data, and in response to the one or more expiration times elapsing, updating, based on the lapsing of the one or more expiration times, one or more entries in the first data structure to indicate that the first data no longer contributes to network congestion.
19. The one or more non-transitory computer-readable media of any of clauses 12-18, wherein the one or more multicast operations are performed during an all-reduce operation.
20. In some embodiments, a system comprises one or more memories storing instructions, and one or more processors that are coupled to the one or more memories and, when executing the instructions, are configured to receive, via a network, first data associated with one or more multicast operations, determine a congestion state of the network based on the first data, and perform one or more operations to reduce an amount of second data that is transmitted via the network based on the congestion state of the network.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for reducing network congestion caused by multicast communications, the method comprising:
receiving, via a network, first data associated with one or more multicast operations;
determining a congestion state of the network based on the first data; and
performing one or more operations to reduce an amount of second data that is transmitted via the network based on the congestion state of the network.

2. The computer-implemented method of claim 1, wherein performing the one or more operations to reduce the amount of second data that is transmitted comprises reducing a number of tokens that permit data to be transmitted based on the congestion state of the network.

3. The computer-implemented method of claim 2, further comprising:
computing a reduction to a watermark based on a number of tokens consumed over a period of time, wherein the tokens that permit data to be transmitted are generated based on the watermark; and
responsive to determining that the reduction to the watermark is less than a constant value, reducing the watermark by the constant value.

4. The computer-implemented method of claim 2, further comprising, when the second data is being transmitted, reducing the number of tokens based on the second data.

5. The computer-implemented method of claim 1, wherein determining the congestion state of the network comprises updating, based on the first data, one or more entries in a first data structure, wherein each entry included in the one or more entries is associated with a respective remote endpoint.

6. The computer-implemented method of claim 5, wherein updating the one or more entries in the first data structure comprises decrementing or incrementing the one or more entries to indicate that the one or more multicast operations are contributing to network congestion.

7. The computer-implemented method of claim 6, further comprising, when the second data is being transmitted, incrementing or decrementing the one or more entries in the first data structure.

8. The computer-implemented method of claim 5, further comprising:
updating, based on the second data, one or more entries in a second data structure that indicates outstanding data from one or more remote endpoints, wherein each entry included in the one or more entries in the second data structure is associated with a respective remote endpoint; and
updating the one or more entries in the first data structure based on the one or more entries in the second data structure.

9. The computer-implemented method of claim 5, further comprising:
storing, in a second data structure, one or more expiration times associated with the first data; and
in response to the one or more expiration times elapsing, updating, based on the lapsing of the one or more expiration times, one or more entries in the first data structure to indicate that the first data no longer contributes to network congestion.

10. The computer-implemented method of claim 9, further comprising computing the one or more expiration times based on when the first data was received, a round trip time, and a delay between data being sent.

11. The computer-implemented method of claim 5, further comprising:
storing, in a second data structure, one or more indications of the first data being outstanding; and
updating at least one entry in the first data structure based on the one or more indications of the first data being outstanding.

12. One or more non-transitory computer-readable media storing instructions that, when executed by at least one processor, cause the at least one processor to perform steps for reducing network congestion, the steps comprising:
receiving, via a network, first data associated with one or more multicast operations;
determining a congestion state of the network based on the first data; and
performing one or more operations to reduce an amount of second data that is transmitted via the network based on the congestion state of the network.

13. The one or more non-transitory computer-readable media of claim 12, wherein performing the one or more operations to reduce the amount of second data that is transmitted comprises reducing a number of tokens that permit data to be transmitted based on the congestion state of the network.

14. The one or more non-transitory computer-readable media of claim 13, wherein the instructions, when executed by the at least one processor, further cause the at least one processor to perform the steps of:
computing a reduction to a watermark based on a number of tokens consumed over a period of time, wherein the tokens that permit data to be transmitted are generated based on the watermark; and
responsive to determining that the reduction to the watermark is less than a constant value, reducing the watermark by the constant value.

15. The one or more non-transitory computer-readable media of claim 12, wherein determining the congestion state of the network comprises updating, based on the first data, one or more entries in a first data structure, wherein each entry included in the one or more entries is associated with a respective remote endpoint.

16. The one or more non-transitory computer-readable media of claim 15, wherein updating the one or more entries in the first data structure comprises decrementing the one or more entries to indicate that the one or more multicast operations are contributing to network congestion, and the instructions, when executed by the at least one processor, further cause the at least one processor to perform the step of:
when the second data is being transmitted, incrementing the one or more entries in the first data structure.

17. The one or more non-transitory computer-readable media of claim 15, wherein the instructions, when executed by the at least one processor, further cause the at least one processor to perform the steps of:
updating, based on the second data, one or more entries in a second data structure that indicates outstanding data from one or more remote endpoints, wherein each entry included in the one or more entries in the second data structure is associated with a respective remote endpoint; and
updating the one or more entries in the first data structure based on the one or more entries in the second data structure.

18. The one or more non-transitory computer-readable media of claim 15, wherein the instructions, when executed by the at least one processor, further cause the at least one processor to perform the steps of:
storing, in a second data structure, one or more expiration times associated with the first data; and
in response to the one or more expiration times elapsing, updating, based on the lapsing of the one or more expiration times, one or more entries in the first data structure to indicate that the first data no longer contributes to network congestion.

19. The one or more non-transitory computer-readable media of claim 12, wherein the one or more multicast operations are performed during an all-reduce operation.

20. A system, comprising:
one or more memories storing instructions; and
one or more processors that are coupled to the one or more memories and, when executing the instructions, are configured to:
receive, via a network, first data associated with one or more multicast operations,
determine a congestion state of the network based on the first data, and
perform one or more operations to reduce an amount of second data that is transmitted via the network based on the congestion state of the network.
